(19) United States
(12) Patent Application Publication
(10) Pub. No.: US 2010/0027531 A1
(43) Pub. Date: Feb. 4, 2010

(54) COMMUNICATION CONTROL APPARATUS, SYSTEM, METHOD AND PROGRAM

(76) Inventor: AKIHISA KURASHIMA, Tokyo (JP)

Correspondence Address: Mr. Jackson Chen, 6535 N. STATE HWY 161, IRVING, TX, 75039, US

(21) Appl. No.: 12/509,627

(22) Filed: Jul. 27, 2009

(30) Foreign Application Priority Data
Jul. 30, 2008 (JP) 196804/2008

(51) Int. Cl. H04L 12/66

(52) U.S. Cl. 370/352

(57) ABSTRACT

A communication control apparatus includes: a communication control unit connected with a relay apparatus relaying a communication between first and second terminals; a request receiver receiving a group hold request from the first terminal for setting a communication status into a group hold state in which the communication is terminated by the relay apparatus and can be responded by third terminal in a group including the first terminal; a hold direction unit making the relay apparatus change the status into the group hold state, if the group hold request is received by the request receiver; a status information provider providing status information to the third terminal; and a communication starting unit making the relay apparatus start a communication between the second and the third terminal, if the communication starting unit receives a response to the group held communication from the third terminal.

### INCORPORATION BY REFERENCE

This application is based upon and claims the benefit of priority from Japanese Application No. 2008-196804, filed on Jul. 30, 2008, the disclosure of which is incorporated herein in its entirety by reference.

### TECHNICAL FIELD

The present invention relates to a communication control apparatus, a communication control system, a communication control method and a communication control program and in particular, relates to the communication control apparatus, the communication control system, the communication control method and the communication control program, which provide service to a terminal in a group.

### BACKGROUND ART

In recent years, in a speech communication (telephone) system, it is being studied to provide a group function to a telephone terminal in a group. The group function is, for example, a function in which a call set into a hold state by a telephone terminal in one group can be picked up by another telephone terminal in the same group. An example of such speech communication system is disclosed in Japanese Patent Application Laid-Open No. 2008-48180 (hereinafter, referred to as “Patent Document 1”).

The speech communication system disclosed in Patent Document 1 is an SIP (Session Initiation Protocol)-based IP (Internet Protocol) telephone system. Patent Document 1 discloses an example of a group function in which it is possible to respond to a call in a hold state, in other words, to pick up the call.

### SUMMARY

An exemplary object of the invention is to provide a communication controller apparatus, a communication control system, a communication control method and a communication control program that can operate so that a terminal in a group may respond to a call of which state has been set into a hold state by another terminal in the group.

A communication control apparatus according to an exemplary aspect of the invention includes: a communication control unit connected with a relay apparatus relaying a communication between a first terminal and a second terminal; a request receiver receiving a group hold request from the first terminal for setting a status of the communication into a group hold state in which the communication is terminated by the relay apparatus and can be responded by a third terminal in a group including the first terminal; a hold direction unit making the relay apparatus change the status into the group hold state, if the group hold request is received by the request receiver; a status information provider providing information about the status to the third terminal; and a communication starting unit making the relay apparatus start a communication between the second terminal and the third terminal, if the communication starting unit receives a response to the communication in the group hold state from the third terminal.

A communication control system according to another exemplary aspect of the invention includes: a first terminal; a second terminal; a relay apparatus relaying a communication between a first terminal and a second terminal; and a communication control apparatus connected with the relay apparatus, and the communication control apparatus comprises: a communication control unit connected with the relay apparatus; a request receiver receiving a group hold request from the first terminal for setting a status of the communication into a group hold state in which the communication can be responded by a third terminal in a group including the first terminal; a hold direction unit making the relay apparatus change the status into the group hold state in which the communication is terminated by the relay apparatus, if the group hold request is received by the request receiver; a status information provider providing information about the status to the third terminal; and a communication starting unit making the relay apparatus start a communication between the second terminal and the third terminal, if the communication starting unit receives a response to the communication in the group hold state from the third terminal.

A communication control method for a communication control apparatus connected with a relay apparatus relaying a communication between a first terminal and a second terminal and communication with the first terminal and the second terminal, according to another exemplary aspect of the invention includes the steps of: receiving a group hold request from the first terminal for setting a status of the communication into a group hold state in which the communication can be responded by a third terminal in a group including the first terminal; making the relay apparatus change the status into the group hold state in which the communication is terminated by the relay apparatus, if the group hold request is received; providing information about the status to the third terminal; and making the relay apparatus start a communication between the second terminal and the third terminal, if a response to the communication in the group hold state is received from the third terminal.

A communication control program for a communication control apparatus connected with a relay apparatus relaying a communication between a first terminal and a second terminal and communication with the first terminal and the second terminal, according to another exemplary aspect of the invention includes the processes of: receiving a group hold request from the first terminal for setting a status of the communication into a group hold state in which the communication can be responded by a third terminal in a group including the first terminal; making the relay apparatus change the status into the group hold state in which the communication is terminated by the relay apparatus, if the group hold request is received; providing information about the status to the third terminal; and making the relay apparatus start a communication between the second terminal and the third terminal, if a response to the communication in the group hold state is received from the third terminal.

### BRIEF DESCRIPTION OF THE DRAWINGS

Exemplary features and advantages of the present invention will become apparent from the following detailed description when taken with the accompanying drawings in which:

FIG. 1 is a block diagram showing an overall configuration of a speech communication system according to a first embodiment;

FIG. 2 shows an example of speech status information according to the first embodiment;

FIG. 3 shows an example of managed terminal information according to the first embodiment;

FIG. 4 shows an example of group information according to the first embodiment;

FIG. 5 is a sequence diagram showing processes of a communication control apparatus for holding a call with respect to a speech relay apparatus according to the first embodiment;

FIG. 6 is an example of a display screen which shows response information for an existing individual held call according to the first embodiment;

FIG. 7 is a sequence diagram showing an example of a procedure to resume the individual held call in the first embodiment;

FIG. 8 is a sequence diagram showing an example of a procedure for changing the individual held call into a group held call according to the first embodiment;

FIG. 9 is an example of a reply screen which is shown after the individual held call is changed into the group held call, according to the first embodiment;

FIG. 10 is a sequence diagram showing an example of procedures for picking up the group held call according to the first embodiment;

FIG. 11 is an example of a reply screen for two existing held calls in a second embodiment;

FIG. 12 is a sequence diagram showing an example of a procedure for transferring a held call according to the second embodiment;

FIG. 13 is a sequence diagram showing a procedure for holding a call in a third embodiment;

FIG. 14 is a block diagram showing a configuration of the communication controller apparatus according to a fourth embodiment;

FIG. 15 is a block diagram showing an overall configuration of the speech communication system according to the fourth embodiment; and

FIG. 16 is a block diagram showing an overall configuration of modification of the speech communication system of the fourth embodiment.

### EXEMPLARY EMBODIMENT

Exemplary embodiments of the present invention will now be described in detail in accordance with the accompanying drawings.

### 1. First Exemplary Embodiment

A first embodiment of the present invention will be described with reference to the drawings. Further, elements in all drawings which correspond to each other have common reference numerals, and descriptions on the elements will be omitted appropriately.

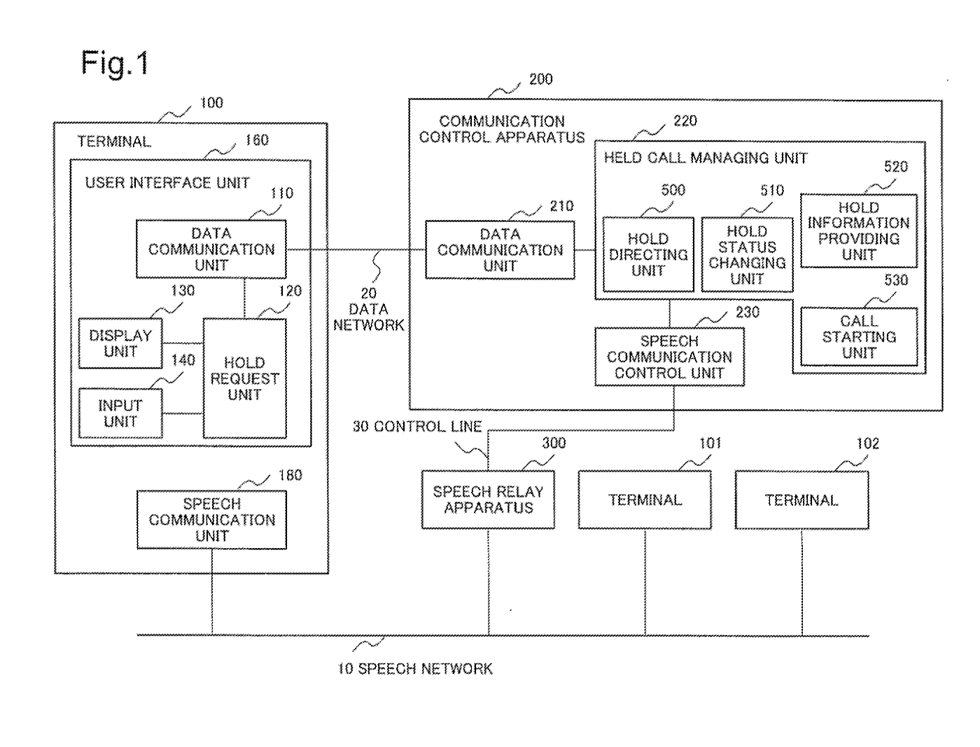

FIG. 1 is a block diagram showing an overall configuration of a speech communication system according to a first embodiment of the present invention. The speech communication system of this embodiment includes a plurality of terminals 100, 101, and 102, a communication control apparatus 200, a speech relay apparatus 300, a speech network 10, a data network 20 and a control line 30. The speech network 10 connects the speech relay apparatus 300 to the terminal 100, the terminal 101 and the terminal 102. The data network 20 connects the communication control apparatus 200 and the terminal 100. The control line 30 connects the communication control apparatus 200 and the speech relay apparatus 300.

The speech network 10 is for example a public telephone network such as a fixed telephone network and a public cellular phone network. The data network 20 is for example an internet network. The control line 30 is for example an RS-232-C cable and a Universal Serial Bus (USB).

In FIG. 1, the speech network 10 and the data network 20 are separated. However, the speech network 10 and the data network 20 may be united. For example, the data network 20 may conduct a function of the speech network 10 in addition to a function of the data network 20 when the speech network 10 is an IP (Internet Protocol) telephone network using a technology of Voice over Internet Protocol (VoIP). In this case, the speech network 10 and the data network 20 can be united.

The terminal 100 includes a User Interface (UI) unit 160 and a speech communication unit 180. The UI unit 160 includes a data communication unit 110, a hold request unit 120, a display unit 130 and an input unit 140. The data communication unit 110 communicates with the communication control apparatus 200. The hold request unit 120 performs a request on hold. The display unit 130 displays a screen for a user of the terminal 100 (hereinafter referred to as “the user”). The input unit 140 receives input from the user. The speech communication unit 180 includes general functions for communicating as a telephone device such as functions of sending, receiving and holding.

In FIG. 1, the terminal 101 and the terminal 102 have the same functions as the terminal 100. Therefore, the terminal 101 and the terminal 102 can also perform all of the same functions as that of terminal 101 explained below. However, as long as the terminal 100, the terminal 101 and the terminal 102 are possible to communicate mutually for speech communication, this embodiment operates properly. Therefore, the terminal 101 and the terminal 102 are required to include at least the same function as the speech communication unit 180. However, the terminal 101 and the terminal 102 are not required to include all the functions of the terminal 100.

The UI unit 160 and the speech communication unit 180 in the terminal 100 are not necessarily required to be placed in one housing. The UI unit 160 and the speech communication unit 180 may be set in different housings.

The terminal 100 may either be a wired telephone terminal (fixed telephone terminal) or a cellular phone terminal. According to this embodiment, the terminal 100 connects with the public telephone network of the speech network 10.

On the other hand, the terminal 101 and the terminal 102 may connect with the public telephone network. Or more specifically, the terminal 101 and the terminal 102 may connect with an extension network in a business enterprise using a Private Branch Exchange (PBX) and the like as the speech relay apparatus 300.

The communication control unit 200 includes a data communication unit 210, a speech control unit 230 and a held call managing unit 220. The data communication unit 210 communicates with the terminal 100. The speech controller unit 230 communicates with the speech relay apparatus 300. The held call managing unit 220 performs information management and hold processing.

In addition, the communication control apparatus 200 is a communication control apparatus that can communicate with the terminal 100, and connects with the speech relay apparatus 300 relaying communication between the plurality of terminals 100, 101 and 102. The communication control apparatus 200 includes the data communication unit 210, a hold directing unit 500, a hold status changing unit 510, a hold information providing unit 520 and a call starting unit 530.

The data communication unit 210 receives a hold request from the terminal 100 that is calling the terminal 101.

The hold directing unit 500 requests speech relay apparatus 300 to shift a status of a call which is being busy (hereinafter referred to as “busy call”) between terminal 100 and terminal 101 to an individual hold state in which the call is terminated by the speech relay apparatus 300.

The hold status changing unit 510 changes the call of which state is changed into the individual hold state (call in an individual hold state is hereinafter referred to as “individual held call”) by the hold directing unit 500, into a call that a terminal in a group including the terminal 100 can respond to (hereinafter referred to as “group held call”).

The hold information providing unit 520 gives information on the group held call to the terminal in the group including the terminal 100.

When a terminal in the group including the terminal 100 responds to the group held call, the call starting unit 530 starts a call with the responding terminal. The responding terminal may be the terminal 100.

Further, according to this embodiment, the held call managing unit 220 includes the hold directing unit 500, the hold status changing unit 510, the hold information providing unit 520 and the call starting unit 530. However, this embodiment is not limited to the above configuration, as long as the hold directing unit 500, the hold status changing unit 510, the hold information providing unit 520 and the call starting unit 530 is included in the communication control apparatus 200 and has the same functions.

The communication control apparatus 200 can be configured using a computer such as personal computer. When the communication control apparatus 200 is configured using the computer, the data communication unit 210, the held call managing unit 220 and the speech control unit 230 operate according to a Central Processing Unit (CPU) that is built in the computer and operates in accordance with a program. The program may be stored in a medium, such as a CR-ROM, DVD-ROM, etc. In addition, if a processing performance is focused, the communication control apparatus 200 may be configured using exclusive hardware and may be connected with other parts through an interface.

Moreover, it is possible to integrate the communication control apparatus 200 and the speech relay apparatus 300 to make one apparatus. In such a case, the control line 30 can be an Application Programming Interface (API) between programs or wiring in the apparatus.

The speech relay apparatus 300 is a relay apparatus which performs speech control of a terminal according to speech control of the communication control apparatus 200.

Next, information managed by the held call managing unit 220 of the communication control apparatus 200 will be described.

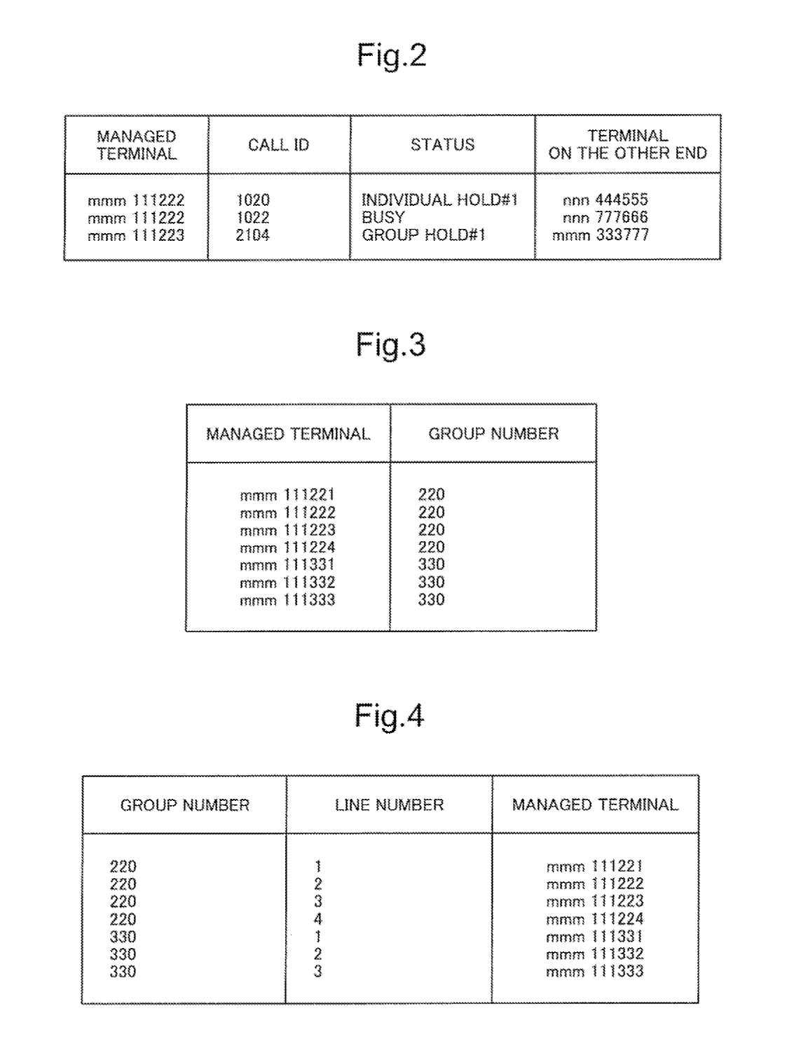

Information managed by the held call managing unit 220 includes speech status information, the managed terminal information and the group information. FIG. 2 shows an example of the speech status information. The speech status information includes identification information of the managed terminal, identification information of a call (hereinafter referred to as “call identification information”), a status of each call and identification information of a terminal at the other end. The speech status information is empty in an initial state of a system, and is updated whenever call control is performed.

Further, with reference to FIG. 2, information on the terminal at the other end included in the speech status information is additional information. The speech status information does not have to include information on the terminal at the other end. Alternatively, the speech status information may include other additional information that should be referred to.

In the item “status” of FIG. 2, “busy”, “individual hold #1” and “group hold #1” are shown. In “individual hold #1”, a call of the terminal is on hold, however, the call is not released to other terminals in the group, therefore the terminals at the other end in the group cannot respond to the call, that is, cannot pick up the call.

Further, in this embodiment, it is possible to include two holds, “individual hold #1” and “individual hold #2”. The difference between “individual hold #1” and “individual hold #2” is that of the terminal at the other end. The terminal 100 of which call with the terminal 101 is in “individual hold #1” can communicate with a terminal except the terminal 101. In the case, if the state of the call with the terminal except the terminal 101 is set into individual hold state, the state of the call becomes “individual hold #2.”

“Group hold #1” means a hold state in which another terminal in a group including a terminal can respond to a held call of the terminal.

FIG. 3 shows an example of the managed terminal information. The managed terminal information includes an identification number of a managed terminal and a group number that is an identification number of a group including the managed terminal. The managed terminal is set in advance by an administrator. Moreover, the managed terminal information can be updated according to a request from the user. Since a management method of the managed terminal information is not directly related to this embodiment, descriptions on the management method are omitted here.

FIG. 4 shows an example of the group information. The group information includes the group number, a line number and an identification number of the managed terminal corresponding to the line number. The group information is set in advance by the administrator. Moreover, the group information can be updated according to the request from the user. Since a management method of the group information is not directly related to this embodiment, descriptions on the management method are omitted here.

Next, operations of the speech communication system of this embodiment will be described. A call of the terminal 100, which is the managed terminal, has to go through the speech relay apparatus 300 in order to work the speech communication system. Therefore, the speech relay apparatus 300 may be an exchange of a public telephone network housing the terminal 100. Further, in the speech communication system, the call may go through the speech relay apparatus 300 according to calling control as disclosed in Japanese Patent Application Laid-Open No. 2006-319958 for example.

Further, relaying the call of the terminal 100 performed by the speech apparatus 300 is not an issue in this embodiment. Furthermore, as explained above, relaying of the call is publicly known. Therefore, descriptions on an establishment method of the call are omitted.

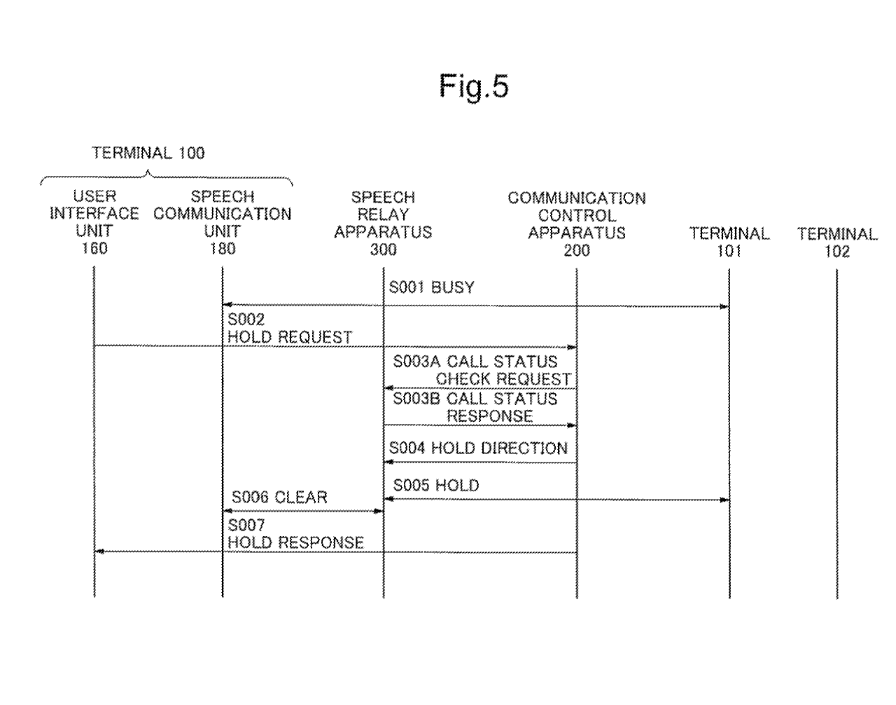

Next, operations of the speech communication system of this embodiment will be described below by referring to FIG. 5 to FIG. 13. FIG. 5 is a sequence diagram showing operations of the communication control apparatus 200 in this embodiment, and shows procedures of the communication control apparatus 200 requesting the speech relay apparatus 300 to hold a call.

First, a call is established between the speech communication unit 180 of the terminal 100 and the terminal 101 (step S001). A call request to establish the call between the terminal 100 and the terminal 101 may be performed from the terminal 100 to the terminal 101, and may be performed from the terminal 101 to the terminal 100. Moreover, the call between the terminal 100 and the terminal 101 may be sent from the speech relay apparatus 300 to the terminal 100 according to third party speech control, and then may be established by sending from the speech relay apparatus 300 to the terminal 101, and vice versa.

In either case, as explained above, a speech control signal such as the SIP goes through the speech relay apparatus 300. Data transmitted by using a Real Time Transport Protocol (RTP) to send call contents does not need to go through the speech relay apparatus 300 between the terminal 100 and the terminal 101.

Next, a hold request is sent to the hold request unit 120 when the user operates the input unit 140 of the UI unit 160 to hold the call. Then, the hold request unit 120 sends a hold request command to the data communication unit 210 of the communication control apparatus 200 through the data communication unit 110 (step S002).

The hold request command includes identification information of the terminal 100. The identification information hereon may be the telephone number of the terminal 100, or may be other identification information on the terminal 100. The hold request command hereon is carried to the held call managing unit 220. A hold confirmation request command is a user-defined command which is defined with request commands defined by Hyper Text Transfer Protocol (HTTP), for example.

Upon reception of the hold request command, the held call managing unit 220 requests the speech relay apparatus 300 to check a speech status through the speech control unit 230 (step S003A). Then, the communication control apparatus 200 identifies the telephone number of the terminal 100 from the identification information thereof included in the hold request command. Requesting the speech relay apparatus 300 to confirm the speech status, the communication control apparatus 200 designates the telephone number.

The speech relay apparatus 300 searches a call corresponding to the designated telephone number and sends call identification information which is management information of a call in the speech relay apparatus 300 as a call status response (step S003B).

In addition, the held call managing unit 220 searches for presence of entry of the speech status information which is the telephone number of the terminal 100 as the managed terminal in order to update the speech status information on the terminal 100. Then, the held call managing unit 220 specifies the call identification information and asks the speech relay apparatus 300 whether or not the call thereof still exists.

If the call does not exist, the entry of the speech status information is deleted. Further, the update of the speech status information associated with termination of the call may be performed when the speech relay apparatus 300 informing the held call managing unit 220 through the speech control unit 230.

When the search of the speech status is completed, the held call managing unit 220 investigates the call status information of the terminal 100 as shown in FIG. 2. For example, when the telephone number of the terminal 100 is mmm111222 (wherein mmm is a positive integer), when the telephone number of the terminal 101 as a terminal at the other end is nnn444555 (wherein nnn is a positive integer) and when the call identification information is 1020, the held call managing unit 220 confirms whether or not the entry in which the managed terminal is mmm111222 and the call identification information is 1020 exists in the speech status information.

If the entry exists in the call status information, the held call managing unit 220 updates the status of the entry to “busy” and sets the number of the terminal at the other end as nnn444555. If the entry does not exist in the call status information, a new entry including the same contents as the updated information is created.

More specifically, the held call managing unit 220 searches for the entry in which the managed terminal is the terminal 100, that is, the entry in which the telephone number is mmm111222. Then, the held call managing unit 220 searches whether or not the entries of individual hold #1 and individual hold #2 exist in the status shown in FIG. 2.

If the entry of the individual hold #1 does not exist in the speech status information, the status of the terminal 101 is changed into individual hold #1 according to the hold direction. Moreover, if the entry of the individual hold #1 exist and the entry of the individual hold #2 does not exist in the speech status information, the status of the terminal 101 is changed into individual hold #2.

Further, a process which is performed when both entries of the individual hold #1 and the individual hold #2 exist in the speech status information may be determined in advance. In this case, for example, a response to the hold confirmation request command may be processed as occurrence of an error. Alternatively, control may be conducted so that the terminal 100 cannot establish a new call.

Then, the held call managing unit 220 sends the hold direction to the speech relay apparatus 300 and update the speech status information at the same time, after it is determined which individual hold state the status of the call is shifted to (step S004). The call identification information and the identification information on the terminal 100, which is a source of the hold request, are given to the hold direction.

The speech relay apparatus 300 which receives the hold direction specifies the call from the call identification information included in the given direction.

Then, the speech relay apparatus 300 specifies the terminal 101, that is, the terminal at the other end, from the identification information of the terminal 100 which is the source of the hold request, and puts the terminal 101-side call in the speech relay apparatus 300 into a hold state (step S005). After putting the terminal 101-side call into the hold state, the speech relay apparatus 300 cuts the terminal 100-side of the same call in the speech relay apparatus 300 (step S006).

Moreover, the held call managing unit 220 which issues the hold direction creates response information. Further, the held call managing unit 220 sends a hold response including the response information to the data communication unit 110 of the terminal 100 through the data communication unit 210 (step S007). Under processes above mentioned, the call between the terminal 100 and the terminal 101 becomes the individual hold state.

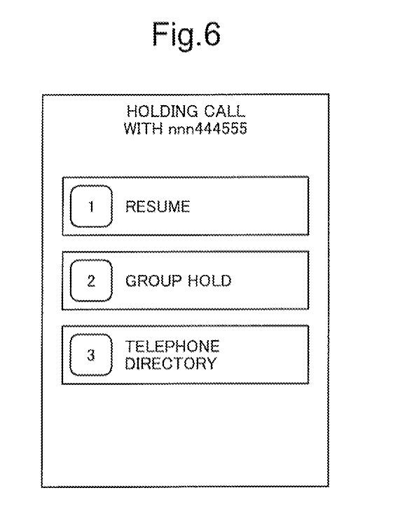

In addition, the response information created in step S007 can be changed according to the number of the individual hold existing at the moment. FIG. 6 shows an example of the display screen that shows the response information corresponding to a case in which only one individual hold exists. In the example of the display in FIG. 6, screen information displayed on the terminal 101 is exactly the response information that the held call managing unit 220 creates.

In this case, the hold request unit 120 receives the response information as a response from the communication control apparatus 200 through the data communication unit 110 of the terminal 100. Then, the terminal 100 displays the response information on the display unit 130 as shown in FIG. 6.

The display screen shown in FIG. 6 shows a function menu including “resume”, “group hold”, and “telephone directory”. The “telephone directory” indicates a function that a call newly starts referring to a telephone directory in the terminal 100 or a server on a network which the terminal 100 is connected with. Descriptions are omitted here since the telephone directory function is not directly related to the purpose of this embodiment. Different functions may be added to the menu.

Further, an example of the display screen shown in FIG. 6 is one display form in this embodiment. A form of information transmittance to display the display screen shown in FIG. 6 does not need to be the form sending the response information as mentioned above. For example, the held call managing unit 220 may send a list of speech status information related to the terminal 100 to the terminal 100. In this case, the terminal 100 creates a display screen such as shown in FIG. 6 from the received speech status information.

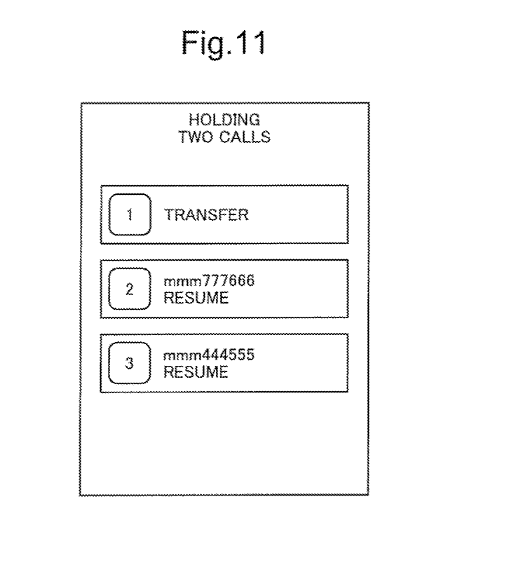

An example of a case in which two individual holds exist in step S007 will be described below referring to FIG. 11.

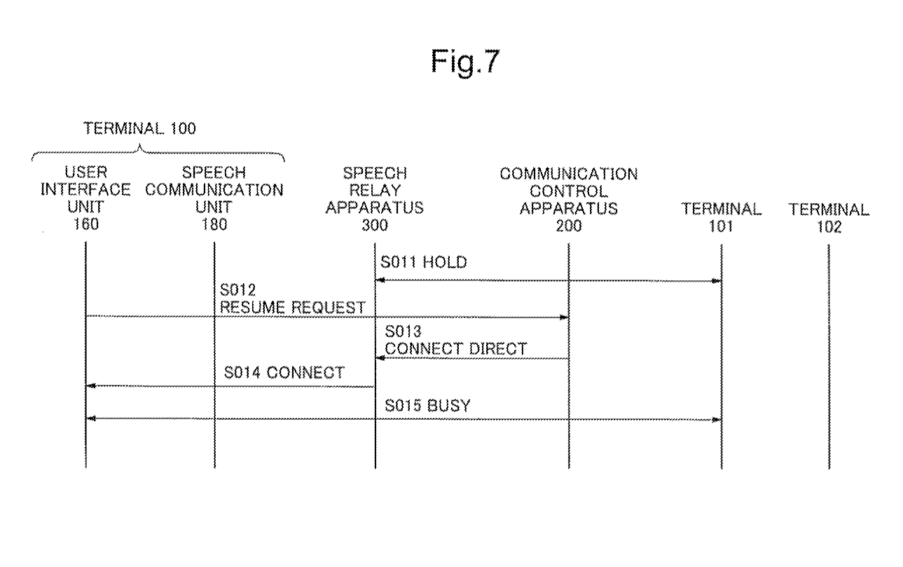

Next, operations which are conducted when the user selects “resume” that is placed at the top of the display screen shown in FIG. 6 are described with reference to FIG. 7. FIG. 7 is a sequence diagram showing an example procedure resuming of a call being held, that is, the held call in this embodiment.

A state of step S011 is a state in which only one held call for the terminal 100 exists. This state is equivalent to the state in which steps up to step S007 are completed as described on FIG. 5.

In the state, the user operates the input unit 140 of the terminal 100 in order to request to resume communication. Upon reception of the request for resume, the hold request unit 120 transmits a resume request command to the data communication unit 210 of the communication control apparatus 200 through the data communication unit 110 (step S012). The resume request command includes the identification information of the call and the identification information of the terminal 100. When receiving the resume request command, the data communication unit 210 transfers the resume request command to the held call managing unit 220.

Held call managing unit 220 directs the speech relay apparatus 300 to connect the held call with the terminal 100 through the speech control unit 230 (step S013).

The speech relay apparatus 300 tries establishment of call with the terminal 100 (step S014). The speech relay apparatus 300 connects the held call with the terminal 100 and enables the speech between the terminal 100 and the terminal 101 when the establishment of the call succeeds (step S015).

When the procedures above mentioned are completed, the held call managing unit 220 updates the call status information. For example, the held call managing unit 220 deletes the call on which the call is established from the speech status information or sets the status of the call to “busy”.

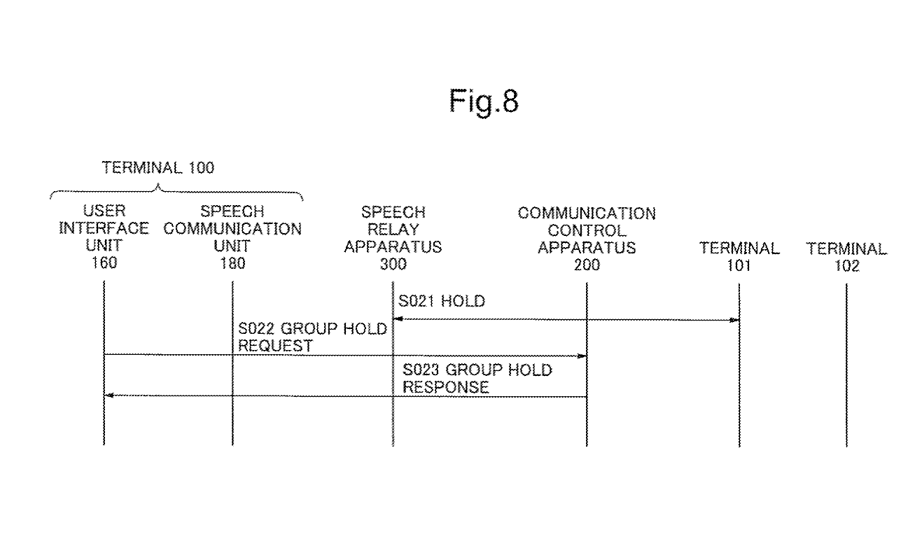

Next, regarding the example of the display screen of FIG. 6, operations, which are performed when the user selects the group hold, will be described referring to FIG. 8. FIG. 8 is a sequence diagram showing an example of procedures in which the individual held call is changed into the group held call in the embodiment.

In a state of step S021, only one individual held call for the terminal 100 exists. The state is equivalent to the state in which procedures up to step S007 are completed as described on FIG. 5.

In the state, the user enters a group hold request into the input unit 140 of the terminal 100 in order to change the individual held call into the group held call. The hold request unit 120 transmits the group hold request command to the data communication unit 210 of the communication control apparatus 200 through the data communication unit 110 when the group hold request reaches the hold request unit 120 (step S022). The group hold request command includes the identification information of the call and identification information of the terminal 100.

The data communication unit 210 of the communication control apparatus 200 which receives the group hold request command sends the group hold request command to the held call managing unit 220. The held call managing unit 220 updates the status of the call in the speech status information into a group hold call state.

Further, an unused state is assigned to “group hold” state by defining a plurality of state such as “group hold #1” and “group hold #2”. The difference between “group hold #1” and “group hold #2” is that of the terminal at the other end. The terminal 100 of which call with the terminal 101 is in “group hold #1” can communicate with a terminal except the terminal 101. In the case, if the call with the terminal except the terminal 101 is set into group hold state, the state of the call becomes “group hold #2.”

When the call is in the group hold state, all terminals in the group including the terminal 100 can reply to the group held call. In order to notify the terminal 100 that the call has been set into a group hold state, the held call managing unit 220 generates group hold response information. Then, the held call managing unit 220 transmits a group hold response to the terminal 100 through the data communication unit 210 (step S023). The group hold response includes the group hold response information.

Now, an example of the generation of the group hold response information, which the held call managing unit 220 transmits to the terminal 100, will be described referring to FIG. 3 and FIG. 4.

First, the held call managing unit 220 specifies the group number to be displayed on the terminal 100 in the managed terminal information of FIG. 3. For example, when the telephone number of the terminal 100 is mmm111222, a group number 220 is obtained from an entry that the telephone number of the managed terminal is mmm111222, according to the example of FIG. 3.

Furthermore, the entry that matches the group number of the group information is obtained from the group information of FIG. 4. In this case, four entries that have the group number 220 are obtained. Still furthermore, the speech status information on the four entries is searched, and the entry, in which a terminal in the group is the managed terminal and a state is set as “group hold”, is obtained. According to the above mentioned processes, the held call managing unit 220 can generate the group hold response information.

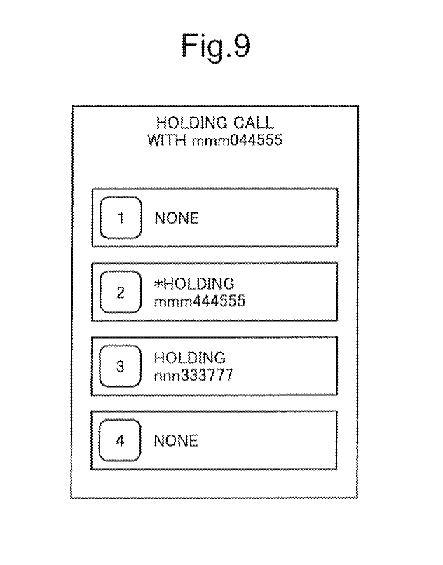

FIG. 9 shows an example of a reply screen which is shown when the individual held call is changed into the group held call in the embodiment. The reply screen shows an example of the speech status information as a result of obtaining the entry from the group information. Specifically, the reply screen shows that as for line 2, the call between the terminal of which telephone number is mmm111222 and the terminal of which telephone number is nnn444555 and is at the other end of the terminal of which telephone number is mmm111222 is a group held call. The reply screen shows that as for line 3, the call between the terminal of which telephone number is mmm111223 and the terminal at the other end of which telephone number is mmm333777 is a group held call.

The line which a call set into hold state by a terminal is assigned to is distinguished using an asterisk (*) and displayed. A method of distinction using the display can be coloring or flashing of characters. In addition, the busy call is not shown in the example of the reply screen of FIG. 9. When a busy call exists, it is possible to obtain the speech status information and perform the display as being busy.

Further, in an example on the reply screen of FIG. 9, only one group held call related to the terminal 100 is shown. When the terminal 100 belongs to more than one groups, a plurality of group held calls may be displayed like a line 2-1 and a line 2-2. The group hold information shown in FIG. 9 is received by the hold request unit 120 from the data communication unit 110 of the terminal 100, and is shown on the display 130.

Incidentally, the display about the group hold can be performed by requesting the list of the group held call from the terminal 100 to the held call managing unit 220, as well as performed as the result of group hold request by the terminal 100. In other words, the terminal 100 sends the identification information of the terminal 100 to the held call managing unit 220 and requests the held call managing unit 220 to send the list of the group held call. Then the terminal 100 does not send group hold request command. As the above, the terminal 100 can obtain the list of the group held call to which the terminal 100 can respond to from the held call managing unit 220 in the form of the reply screen shown in FIG. 9.

Further, the held call managing unit 220 transmits the group held call list to the terminal 100 according to the embodiment. The held call managing unit 220 may transmit the list of the group held call to another terminal in a group including the terminal 100. As a result, since the terminal in a group including the terminal 100 can obtain the group hold information, the terminal can connect to the terminal at the other end which stays in the group hold.

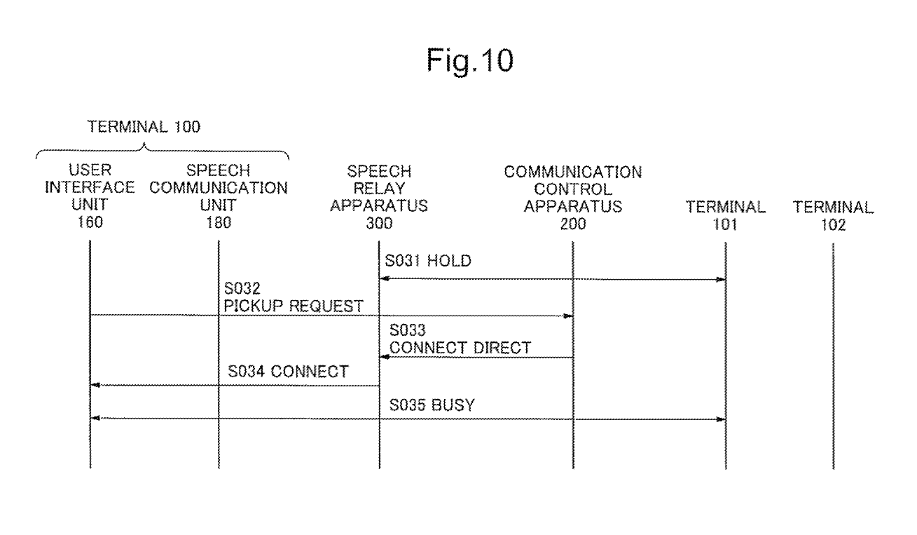

When the example of the reply screen of FIG. 9 is displayed on the terminal 100, pickup procedure starts if the user operates the input unit 140 to select the lines 2 or the line 3. FIG. 10 is a sequence diagram showing an example of procedures of picking up the group held call in the embodiment. As described above, “pick up” means to respond to a group held call.

A state of step S031 is the state in which the group held call in the speech relay apparatus 300 exists. The state is equivalent to a state in which procedures up to step S023 are completed as described on FIG. 8.

In order to select a line in the state, the user operates the input unit 140 of a terminal 100. The hold request unit 120 transmits the pickup request command to the communication control apparatus 200 through the data communication unit 110 when the request for the line selection reaches the hold request unit 120 (step S032). The pickup command includes the identification information on the terminal 100 and the call identification information.

Further, information which designates the call included in the pickup request command may be the line number, or the call identification information. When the line number is the information that designates the call, the held call managing unit 220 specifies the call using the managed terminal information, the group information and the speech status information.

The pickup request command is received in the data communication unit 210 of the communication control apparatus 200, and is sent to the held call managing unit 220.

The held call managing unit 220 specifies the terminal 100 and the call from the information included in the pickup request command. The held call managing unit 220 directs the speech relay apparatus 300 to connect the group held call to the terminal 100 through the speech control unit 230 (Step S033).

The speech relay apparatus 300 that receives the direction tries the establishment of the call with the terminal 100 (step S034). The speech relay apparatus 300 connects the held call to the terminal 100 and enables the speech between the terminal 100 and the terminal 101 when establishment of the call succeeds (step S035).

When the above mentioned procedures are completed and the establishment of the call succeeds, the held call managing unit 220 updates the call status information. For example, the held call managing unit 220 deletes the call in which the establishment of the call succeeds from the speech status information, or changes the status of the call to being “busy”.

As described above, the terminal 100 connected to the speech network 10 provides a request for changing to a hold state including the group hold state to the communication control apparatus 200 through data network 20 according to the speech communication system of the first embodiment. The communication control apparatus 200 manages the hold state of the call and gives the response information on the call being held to a terminal in the group including the terminal 100.

Therefore, the speech communication system of the embodiment can provide a group hold service in which a terminal in a group can respond.

### 2. Second Exemplary Embodiment

According to the first embodiment, only one individual held call exists. In the speech communication control system of the present invention, more than one individual held call can exist. As the second embodiment, an example of the embodiment in which two individual held calls exist will be described.

FIG. 11 shows an example of a reply screen which is displayed when two held calls exist. In an example of the reply screen shown in FIG. 11, “resume” of call of one of individual held calls or “transfer” which starts a call between two terminals of which calls are set in the individual hold state can be selected. Regarding the resumption of the call, procedures as described on FIG. 7 are performed.

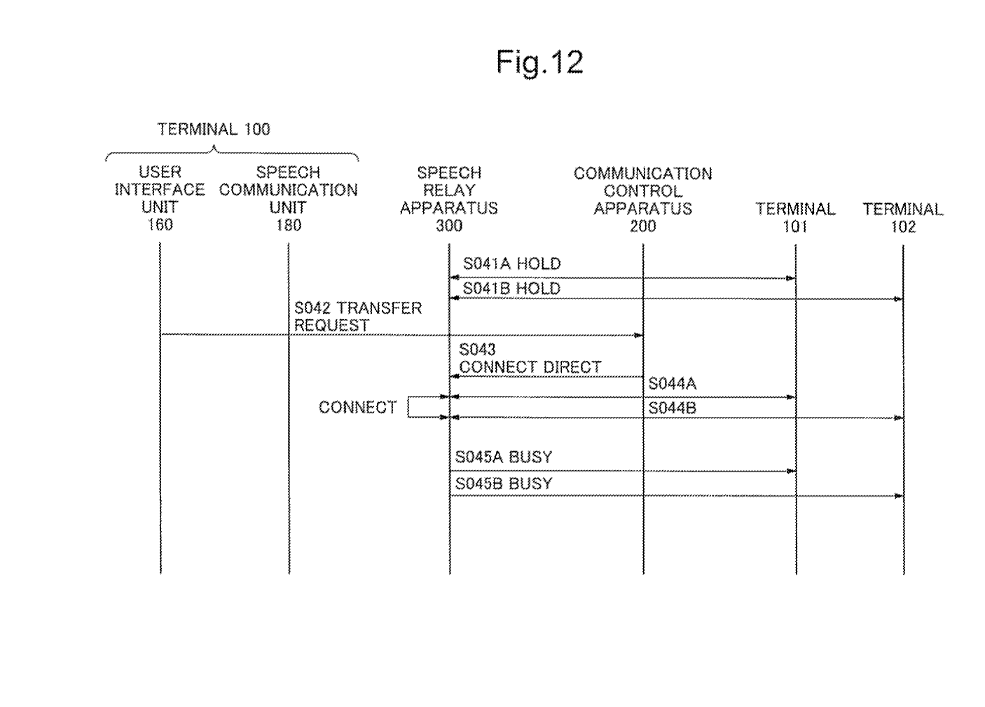

An example of transferring procedures for requesting start of call between two held terminals is shown in FIG. 12. FIG. 12 is a sequence diagram showing an example of transferring procedures for requesting start of a call between two terminals of which calls are set in the individual hold state.

A state of step S041A and a state of step S041B are states that there are the two terminals at the other end of the terminal 100 of which calls with the terminal 100 are held, which are the terminal 101 and the terminal 102, respectively. The states are equivalent to states in which procedures up to step S007 which are described on FIG. 5 are completed with respect to the terminal 101 and the terminal 102.

Then, in order to transfer the individual held call, the user enters a transfer request into the input unit 140 of the terminal 100. When the transfer request reaches the hold request unit 120, the hold request unit 120 sends s transfer request command to the data communication unit 210 of the communication control apparatus 200 through the data communication unit 110 (step S042). The transfer request command includes two pieces of call identification information and identification information of the terminal 100. The data communication unit 210, which receives the transfer request command, transfers the transfer request command to the held call managing unit 220.

The held call managing unit 220 confirms the speech status information and confirms the designated call comes from the terminal 100. Then, the held call managing unit 220 directs the speech relay apparatus 300 to connect the calls being held, through the speech control unit 230 (Step S043).

The speech relay apparatus 300 that receives the request tries connection between the two individual held calls (step S044A and S044B). When the connection succeeds, speech between terminal 101 and terminal 102 through the speech relay apparatus 300 becomes possible (step S045 and S045B).

When the above mentioned procedures succeeds, the held call managing unit 220 updates the speech status information. For example, two pieces of the call identification information is deleted from the speech status information.

As mentioned above, in the speech communication system of the second embodiment, the terminal 100 connected to the speech network 10 provides a request to change into a hold state including a group hold state to the communication control apparatus 200 through the data network 20. Furthermore, the terminal 100 can set two calls with two different terminals at the other end of the terminal 100 into individual hold state. The communication control apparatus 200 manages a hold state of the call and gives response information on the call being held to a terminal in the group including the terminal 100. Therefore, in the speech communication system of the embodiment, the transfer service to connect two terminals in which call is in a hold state can be provided.

### 3. Third Exemplary Embodiment

In the first and second embodiments, the various commands from the terminal 100 are transmitted to the held call managing unit 220 through the data communication unit 110 from the hold request unit 120 of the terminal 100. The various commands includes an individual hold request command, a group hold request command, a resume request command, a pickup request command and a transfer request command. As a different route for transmitting these commands, the speech communication unit 180 of the terminal 100 may be used.

Next, as a third embodiment, procedures are performed when the individual hold request command is sent using the speech communication unit 180 will be described. The individual hold request command is an example of commands sent from the terminal 100. The procedures for sending the other commands to the held call managing unit 220 are common to that of the individual hold request command. The operations after the other commands reach the held call managing unit 220 are common to that described in the first and second embodiments.

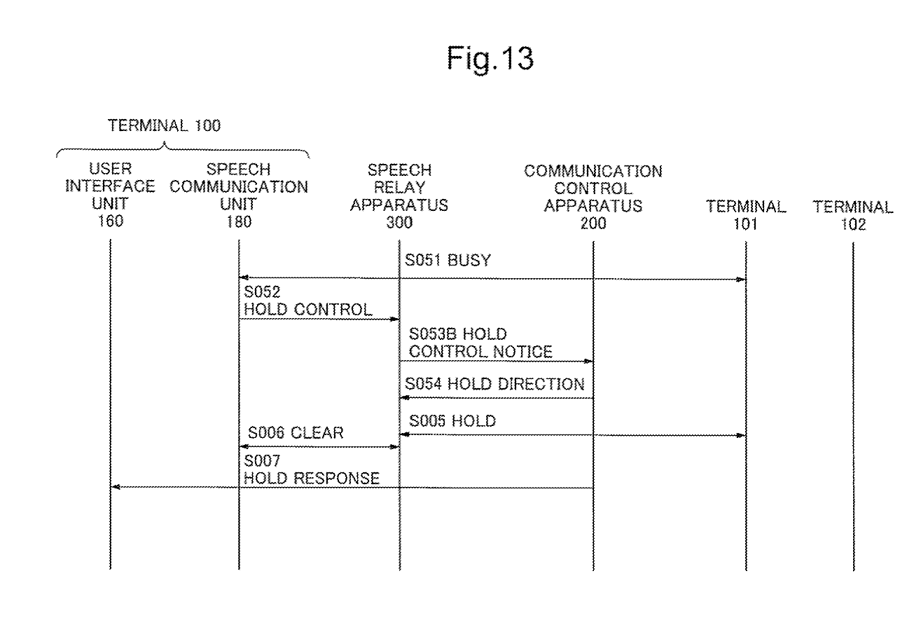

An example of a sequence diagram showing procedures up to hold of the call which are carried out when the individual hold request is taken out through the speech communication unit 180 is shown in FIG. 13. FIG. 13 shows procedures up to a step in which the communication control apparatus 200 directs the speech relay apparatus 300 to hold call.

At first, the line between the terminal 100 and the terminal 101 is busy (step S051). In the above mentioned step, a call may be established by any kind of method.

The speech communication apparatus 180 transmits a hold control signal for holding call and a terminal to the speech relay apparatus 300, when the user operates the input unit 140 to hold the call with terminal 101 (step S052).

When receiving the hold control signal, the speech relay apparatus 300 sends a notification on reception of the hold control signal (hereinafter “hold control notice”) to the speech control unit 230 of the communication control apparatus 200 (step S053).

The hold control notice is sent to the held call managing unit 220 from the speech control unit 230. Moreover, the held call managing unit 220 confirms speech status information of the terminal 100.

For example, when a telephone number of the terminal 100 is mmm111222, the held call managing unit 220 searches for the entry in which the managed terminal is the terminal 100, that is, the entry that the value of the telephone number is mmm111222. Then, the held call managing unit 220 investigates whether or not entries of individual hold #1 and individual hold #2 exist in the speech status information of the terminal 100.

If the entry of the individual hold #1 does not exist in the speech status information, the state of the call of the terminal 101 is shifted into the state of the individual hold #1 according to the hold direction. Moreover, if the entry of the individual hold #1 exist and the entry of the individual hold #2 does not exist in the speech status information, the state of the call of the terminal 101 is shifted into the state of the individual hold #2.

Further, processes which are performed when both entries of the individual hold #1 and the individual hold #2 exist in the speech status information can be determined in advance. In such a case, for example, response to the hold control notice may be processed as occurrence of an error. Or more specifically, when the individual hold #1 and the individual hold #2 exist, processes may be carried out so that the terminal 100 cannot establish a call newly.

Then, the held call managing unit 220 updates the speech status information and gives hold direction to the speech relay apparatus 300, when the individual hold state to which the call is shifted is determined (step S054). Call identification information and identification information of the terminal 100, which is a source of a hold request, are given to the hold direction.

Further, before step S054, a setup of a call state into the hold state may be completed on the side of the terminal 100 according to the function of the speech network 10. In this case, in step S054, the terminal 101 is shifted into the hold state in which the speech relay apparatus 300 becomes termination, and the call between the terminal 100 and the speech relay apparatus 300.

Processes described below are equal to steps S005 to S007 shown in FIG. 5. Specifically, the speech relay apparatus 300 which receives the hold direction specifies the call from the call identification information included in the direction. Then, the speech relay apparatus 300 specifies the side of the terminal 101 as a terminal at the other end from the information of the terminal 100, and sets the call on the side of the terminal 101 of the speech relay apparatus 300 into the hold state (step S005). After setting the call on the side of the terminal 101 into the hold state, the speech relay apparatus 300 cuts the side of the same call of the terminal 100 of the speech relay apparatus 300 (step S006). Moreover, the held call managing unit 220 which issues the hold direction creates the response information. Further, the held call managing unit 220 sends a hold response including the response information to the data communication unit 110 of the terminal 100 through the data communication unit 210 (step S007). According to the above mentioned processes, the call between the terminal 100 and the terminal 101 is set into the individual hold state.

Further, in order to use the procedure as shown in FIG. 13, predetermined mounting or setting for sound network 10 is necessary so that the hold control signal which is the hold request from the side of speech communication unit 180 by the terminal 100 reaches the speech relay apparatus 300.

As mentioned above, in the speech communication system of the third embodiment, the terminal 100 sends various requests to the speech relay apparatus 300. The exchange of control signals between the terminal 100 and the communication control apparatus 200 is not required. Therefore, the terminal 100 has an advantage that the terminal 100 does not need to have interface to the communication control apparatus 200. Furthermore, the terminal 100 has another advantage that the terminal 100 has only to send a hold request signal to the line for speech communication as well as speech signal, in order to request the change of the status of the call.

The above advantages can be obtained by the change of the status of the call into group hold state. Therefore, the speech communication system of the third embodiment can provide a group hold service in which a terminal in a group can respond, as well as the first and second embodiments.

### 4. Fourth Exemplary Embodiment

The present invention can be applied not only to speech communication but also to an image or general data communication. A communication control apparatus of the fourth embodiment is a generalized communication control apparatus 200 of the first through the third embodiments. A “call” meaning the speech communication in the first through the third embodiments is generalized to “communication” in the fourth embodiment. The communication control apparatus of the fourth embodiment can perform general communication including the speech communication. The communication control apparatus of the fourth embodiment has only elements indispensable to the present invention.

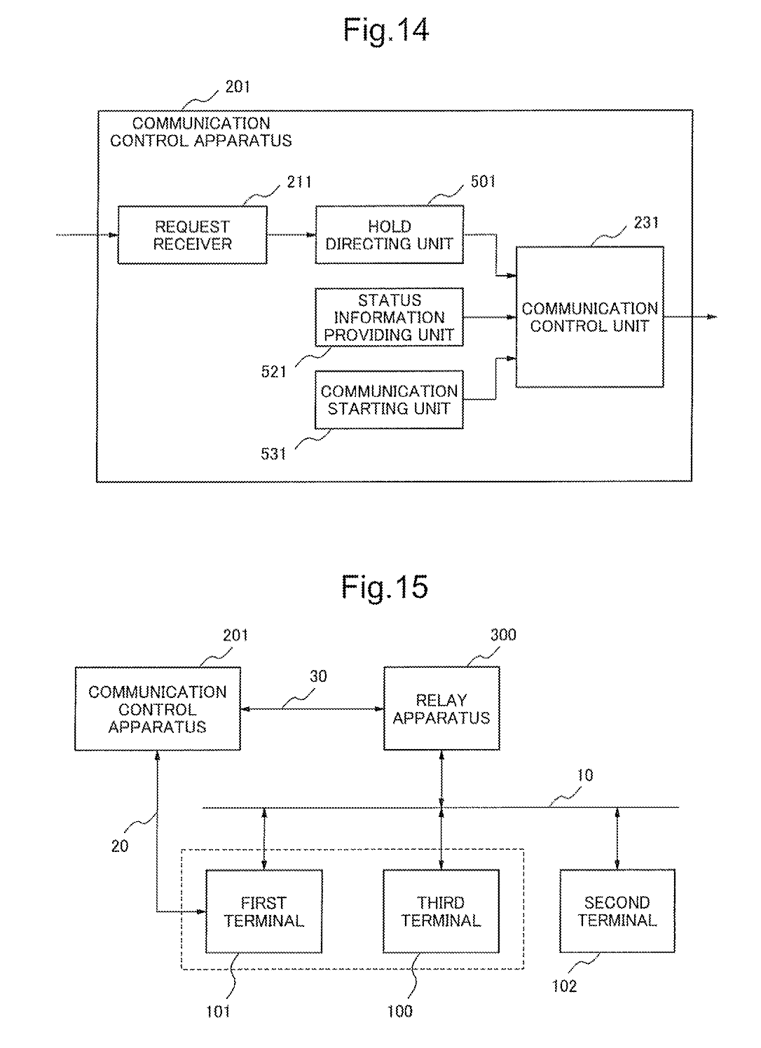

FIG. 14 is a block diagram showing a configuration of a communication control apparatus 201 of this embodiment. The communication control apparatus 201 includes a request receiver 211, a hold directing unit 501, a status information providing unit 521, a communication starting unit 531 and a communication control unit 231.

The request receiver 211 receives various requests from an external apparatus (hereinafter, referred to as “the first terminal”). This request includes a group hold request. Moreover, the request may include an individual hold request, a resume request, a pickup request, an information providing request and a transfer request. The first terminal communicates with another external apparatus (hereinafter referred to as “the second terminal”) through a predetermined relay apparatus.

When the request receiver 211 receives the group hold request from the first terminal, the hold directing unit 501 sets the state of the communication between the first terminal and the second terminal (hereinafter referred to as “target communication”) into “group hold state”.

The first terminal that sends the group hold request and all terminals including the first terminal can reply to the target communication in the “group hold state” (hereinafter referred to as “group held communication”). More specifically, another terminal in the group including the first terminal (hereinafter referred to as “the third terminal”) can reply to the communication set into the group hold state between the first terminal and the second terminal instead of the first terminal. The reply means to pick up the group held communication and begin communication.

Further, the communication control apparatus 200 in the first through third embodiments once sets the target communication into the individual hold communication, and next, shifts the individual hold communication into the group held call. In contrast, the communication control apparatus 201 of the fourth embodiment directly sets the target communication into the group hold state. The communication control apparatus 201 of the fourth embodiment may function to once set the target communication into the individual hold communication and may function to shift the individual hold communication into the group held call, as described in the first through third embodiments. When the request receiver 211 receives the group hold request, the hold directing unit 501 set the state of the target communication into “group hold state” in which the relay apparatus is a termination. The status information providing unit 521 stores information on the state of the communication (hereinafter referred to as “status information”). The status information includes classification of the state such as the group hold state. Moreover, the status information may include the identification information on two terminals which perform communication in the group hold state.

The status information providing unit 521 transmits the status information to the third terminal. At the moment, the status information providing unit 521 may transmit the status information to all terminals in the group. More specifically, the status information providing unit 521 may transmit the status information to a specific terminal, for example, the first terminal. The status information providing unit 521 may transmit the status information to the terminal, when the request receiver 211 receives the information providing request from the first terminal.

The communication starting unit 531 starts the communication between the first terminal and the second terminal in the group hold state, between the second terminal and the third terminal. The communication starting unit 531 resumes communication, when the request receiver 211 receives a reply from the third terminal, for example. The reply from the third terminal is a request sent by the third terminal in order to pick up the communication in the group hold state. Obtaining the status information, the third terminal can recognize that the communication between the first terminal and the second terminal is in the group hold state. The reply from the third terminal may be transmitted to the communication control apparatus 201 through the relay apparatus.

The communication control unit 231 controls communication between the communication control apparatus 201 and the relay apparatus. For example, the communication control unit 231 transmits a command such as the above-mentioned group hold request to the relay apparatus and transmits various directions.

As described above, the communication control apparatus of the fourth embodiment receives a request from the first terminal, and requests the relay apparatus to set the communication between the first terminal and the second terminal into the group hold state. The communication control apparatus transmits the state of the communication to other terminals in the group. Therefore, in the embodiment, communication in the group hold state is resumed between the third terminal and the second terminal in a group.

An example of a configuration of the communication control system including the above-mentioned communication control apparatus 201 is described. FIG. 15 is a block diagram showing an overall configuration of the communication control system of the fourth embodiment. The communication control system includes a communication control apparatus 201, a relay apparatus 300, a first terminal 100, a second terminal 101 and a third terminal 102. Further, the relay apparatus 300, the first terminal 100, the second terminal 101 and the third terminal 102 corresponds to counterparts in the first embodiment.

The relay apparatus 300, the first terminal 100, the second terminal 101 and the third terminal 102 are connected with each other through the first communication line. The first communication line is, for example, an audio communication line such as a telephone line. The communication control apparatus 201 and the first terminal 100 are connected by the second communication line. The second communication line is for example a data communication line such as the internet or a leased line through which a control signal can be transmitted.

First terminal 101 transmits the group hold request to the communication control apparatus 201 through the second communication line 20.

The communication control apparatus 201 sends various directions to the relay apparatus 300 through a control line 30.

There is a difference between the first communication line and the second communication line. The first communication line is a line through which communication between the terminals is conducted, and the second communication line is a line through which communication between the first terminal 100 and the communication control apparatus 201 is conducted. Therefore, the first communication line has a role of the second communication line, and the second communication line has a role of the first communication line. Accordingly, the first communication line and the second communication line can be united.

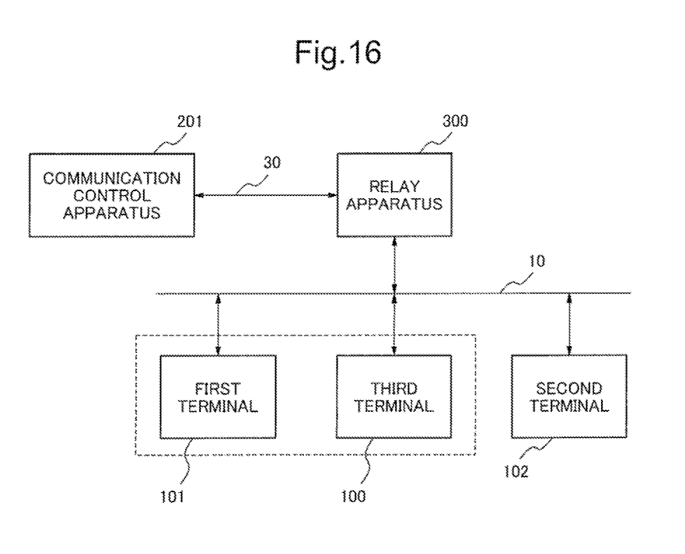

FIG. 16 is a block diagram showing an overall configuration of the communication control system in which the group hold request from the first terminal 101 to the communication control apparatus 201 is transmitted through the first communication line.

In a communication control system of FIG. 16, the group hold request from the first terminal 101 to the request receiver 211 is transmitted through the first circuit 10, the relay apparatus 300 and the control line 30.

Even if the communication control system is in either forms of FIG. 15 or FIG. 16, the communication control apparatus 201 can receive the group hold request from first terminal 101 using the request receiver 211. Moreover, the communication control apparatus 201 can conduct predetermined processes above mentioned according to the request.

The first through fourth embodiments of the present invention are described with reference to the drawings. The above-mentioned embodiments are examples of the embodiments of the present invention and various configurations other than configurations above described are possible. Moreover, each embodiment can be combined appropriately.

### 5. Fifth through Eighth Exemplary Embodiment

The above-mentioned patent document discloses an art which carries out a group function in a hold state using an extended SIP command newly defined. In the art, the extended SIP command is used. Therefore, in a private network of a company using Private Branch Exchange (PBX), the art can be used, when a terminal being used is limited to a terminal corresponding to the extended SIP command, for example.

On the other hand, call service in a public network provides functions in which hold/resumption of the call is conducted, a second call is generated while a first call is held, and the first call is replaced with the second call. However, in a speech communication system in the public network, a group function is not currently provided.

As mentioned above, by limiting a terminal to a terminal which can use the extended SIP command, the art disclosed in the patent document can be applied to a private network in a company using the PBX. However, it is required that a terminal connected to the public network has a function based upon the predetermined average communication standard. Therefore, it is very difficult to use an extended command which is not defined by the communication standard.

A communication control apparatus of the fifth embodiment of the present invention is connected to a speech relay apparatus that relays a call between a plurality of terminals, and can communicate with the terminal. The communication control apparatus includes: a hold request receiving means for receiving a hold request from a first terminal busy communicating with the terminal at the other end; a hold directing means for requesting the speech relay apparatus to shift a state of a call calling with the first terminal into a hold state when a hold request receiving means receives the hold request; a hold status changing means for changing the held call which has been shifted into the hold state by the hold directing means to a group held call to which other terminals in a group including the first terminal respond; a hold information providing means for providing information of the group held call changed by the hold status changing means to the terminals in the group including the first terminal; and a call starting means for starting calling with the second terminal making a response when a terminal in the group including the first terminal responds to a call from a terminal in a group including the first terminal to the second terminal responding to the group held call.

A speech relay method of the sixth embodiment of the present invention is the speech relay method in a communication control apparatus which is connected to a speech relay apparatus that relays a call between a plurality of terminals and can communicate with the terminal. The speech relay method includes: a hold request receiving step of receiving a hold request from first terminal busy communicating with the terminal at the other end; a hold directing step of requesting the speech relay apparatus to shift a state of a call calling with the first terminal into a hold state in which the speech relay apparatus is termination when the hold request is received in the hold request receiving step; a hold status changing step of changing the call which has been shifted to the hold state in the hold directing step to a group held call to which a terminal in a group including the first terminal can responds; a group hold information providing step of providing the terminal in the group including the first terminal with information of the group held call in the hold status changing step; and a call starting step of starting calling with a second terminal making a response when the terminal in the group including the first terminal responds to the group held call.

A speech relay program of the seventh embodiment of the present invention is the speech relay program in a communication control apparatus which is connected to a speech relay apparatus that relays a call between a plurality of terminals and can communicate with the terminal. The speech relay program makes a computer conduct the following procedures. The procedures include: a hold request receiving procedure of receiving a hold request from first terminal busy communicating with the terminal at the other end; a hold directing procedure of requesting the speech relay apparatus to shift a state of a call calling with the first terminal into a hold state in which the speech relay apparatus is termination when the hold request is received in the hold request receiving procedure; a hold status changing procedure of changing the call which has been shifted to the hold state in the hold directing procedure to a group held call to which a terminal in a group including the first terminal can responds; a group hold information providing procedure of providing the terminal in the group including the first terminal with information of the call the group held call in the hold status changing procedure;, and a call starting procedure of starting calling with a second terminal making a response when the terminal in the group including the first terminal responds to the group held call.

A speech communication system of the eighth embodiment of the present invention is the speech communication system which includes a plurality of terminals, a speech relay apparatus that relays a call between a plurality of terminals and a communication control apparatus which is connected to the speech relay apparatus and which can communicate with a terminal. The speech relay apparatus includes: a hold request receiving means for receiving a hold request from a first terminal busy communicating with the terminal at the other end; a hold directing means for making the speech relay apparatus shift the call calling with the first terminal into a hold state in which the speech relay apparatus is termination when the hold request is received by the hold request receiving means; a hold state changing means for changing the call which has been shifted to the hold state by the hold directing procedure into a group held call to which a terminal in a group including the first terminal can responds; a group hold information providing means for providing the terminal in the group including the first terminal with information of the group held call by the hold state changing means; and a call starting means for starting calling with a responding second terminal when a terminal in the group including the first terminal responds to the group held call.

According to the fifth through eighth embodiments of the present invention, the speech control apparatus, the speech relay method, the speech relay program and the speech communication system which enable a terminal connected to a public network to reply to a group held call between other terminals in a group.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. A communication control apparatus comprising:
a communication control unit connected with a relay apparatus relaying a communication between a first terminal and a second terminal;
a request receiver receiving a group hold request from the first terminal for setting a status of the communication into a group hold state in which the communication is terminated by the relay apparatus and can be responded by a third terminal in a group including the first terminal;
a hold direction unit making the relay apparatus change the status into the group hold state, if the group hold request is received by the request receiver;
a status information provider providing information about the status to the third terminal; and
a communication starting unit making the relay apparatus start a communication between the second terminal and the third terminal, if the communication starting unit receives a response to the communication in the group hold state from the third terminal.

2. The communication control apparatus according to claim 1, wherein
the request receiver receiving a individual hold request from the first terminal for setting a status of the communication into a individual hold state in which the communication is terminated by the relay apparatus and can be responded only by the first terminal, and
the hold direction unit makes the relay apparatus change the status into the individual hold state, when the individual hold request is received by the request receiver.

3. The communication control apparatus according to claim 2, wherein
the hold direction unit makes the relay apparatus change the status from the individual hold state into the group hold state, if the group hold request is received by the request receiver when the status is the individual hold state.

4. The communication control apparatus according to claim 1, wherein
the relay apparatus, the first terminal and the second terminal are connected with a first communication network, and
the hold request receiver is connected with the first terminal through a second communication network and receives the group hold request from the first terminal through the second communication network.

5. The communication control apparatus according to claim 4, wherein
the first communication network transmits a signal including a speech signal, and
the second communication network transmits a signal including data.

6. The communication control apparatus according to claim 1, wherein
the relay apparatus, the first terminal and the second terminal are connected with a first communication network, and
the request receiver is connected with the communication control unit and receives the group hold request from the first terminal through the apparatus.

7. The communication control apparatus according to claim 6, wherein
the first communication network transmits a signal including a speech signal, and
the second communication network transmits a signal including data.

8. The communication control apparatus according to claim 1, wherein
the hold directing unit makes the relay apparatus resume the communication, if the request receiver receives a resume request from the first terminal for resuming the communication in the group hold state.

9. The communication control apparatus according to claim 1, wherein
if a first communication between the first terminal and a fourth terminal and a second communication between the first terminal and a fifth terminal are in the hold state and the request receiver receives a transfer request from the first terminal for connecting the first communication and the second communication, the hold directing unit makes the relay apparatus connect the first communication and the second communication.

10. The communication control apparatus according to claim 1, wherein
the status information providing unit provides a list of a communication in the group hold state to all terminals in the group.

11. A communication control apparatus comprising:
a communication control means for connecting with a relay apparatus relaying a communication between a first terminal and a second terminal;
a request receiving means for receiving a group hold request from the first terminal for setting a status of the communication into a group hold state in which the communication is terminated by the relay apparatus and can be responded by a third terminal in a group including the first terminal;
a hold directing means for making the relay apparatus change the status into the group hold state, if the group hold request is received by the request receiver;
a status information providing means for providing information about the status to the third terminal; and
a communication starting means for making the relay apparatus start a communication between the second terminal and the third terminal, if the communication starting unit receives a response to the communication in the group hold state from the third terminal.

12. A communication control system comprising:
a first terminal;
a second terminal;
a relay apparatus relaying a communication between a first terminal and a second terminal; and
a communication control apparatus connected with the relay apparatus, wherein
the communication control apparatus comprises:
a communication control unit connected with the relay apparatus;
a request receiver receiving a group hold request from the first terminal for setting a status of the communication into a group hold state in which the communication can be responded by a third terminal in a group including the first terminal;
a hold direction unit making the relay apparatus change the status into the group hold state in which the communication is terminated by the relay apparatus, if the group hold request is received by the request receiver;
a status information provider providing information about the status to the third terminal; and
a communication starting unit making the relay apparatus start a communication between the second terminal and the third terminal, if the communication starting unit receives a response to the communication in the group hold state from the third terminal.

13. A communication control system comprising:
a first terminal;
a second terminal;
a relay apparatus relaying a communication between a first terminal and a second terminal; and
a communication control apparatus connected with the relay apparatus, wherein
the communication control apparatus comprises:
a communication control means for connecting with the relay apparatus;
a request receiving means for receiving a group hold request from the first terminal for setting a status of the communication into a group hold state in which the communication can be responded by a third terminal in a group including the first terminal;
a hold directing means for making the relay apparatus change the status into the group hold state in which the communication is terminated by the relay apparatus, if the group hold request is received by the request receiver;
a status information providing means for providing information about the status to the third terminal; and
a communication starting means for making the relay apparatus start a communication between the second terminal and the third terminal, if the communication starting unit receives a response to the communication in the group hold state from the third terminal.

14. A communication control method for a communication control apparatus connected with a relay apparatus relaying a communication between a first terminal and a second terminal and communication with the first terminal and the second terminal, comprising the steps of:
receiving a group hold request from the first terminal for setting a status of the communication into a group hold state in which the communication can be responded by a third terminal in a group including the first terminal;
making the relay apparatus change the status into the group hold state in which the communication is terminated by the relay apparatus, if the group hold request is received;
providing information about the status to the third terminal; and
making the relay apparatus start a communication between the second terminal and the third terminal, if a response to the communication in the group hold state is received from the third terminal.

15. A communication control program for a communication control apparatus connected with a relay apparatus relaying a communication between a first terminal and a second terminal and communication with the first terminal and the second terminal, comprising the processes of:
receiving a group hold request from the first terminal for setting a status of the communication into a group hold state in which the communication can be responded by a third terminal in a group including the first terminal;
making the relay apparatus change the status into the group hold state in which the communication is terminated by the relay apparatus, if the group hold request is received;
providing information about the status to the third terminal; and
making the relay apparatus start a communication between the second terminal and the third terminal, if a response to the communication in the group hold state is received from the third terminal.

16. A medium storing the communication control program according to claim 13.
